(19) United States
(12) Patent Application Publication
(10) Pub. No.: US 2004/0110060 A1
(43) Pub. Date: Jun. 10, 2004

(54) Membrane-electrode assembly and production method thereof

(75) Inventor: Nobuo Yodoshi, Aichi-ken (JP)

Correspondence Address: Finnegan, Henderson, Farabow,, Garrett & Dunner, L.L.P., 1300 I Street, N.W., Washington, DC, 20005-3315, US

(73) Assignee: Toyota Jidosha Kabushiki Kaisha

(21) Appl. No.: 10/724,747

(22) Filed: Dec. 2, 2003

(30) Foreign Application Priority Data
Dec. 9, 2002 (JP) 2002-356957
Feb. 27, 2003 (JP) 2003-050498

(51) Int. Cl. H01M 4/96; B05D 5/12; H01M 4/88

(52) U.S. Cl. 429/44; 427/115; 502/101

(57) ABSTRACT

A carrier is subjected to a crushing process before carrier supported catalyst-containing ink including a catalyst, a carrier, and a solvent is prepared. Using the carrier, the carrier supported catalyst-containing ink is prepared. The ink is further subjected to a filtration process, or a disintegration process as required such that the number of the agglutinates (catalyst clumps) contained in the catalyst or the carrier supported catalyst in the ink is reduced. Then, the ink is applied to an electrolyte membrane.

### INCORPORATION BY REFERENCE

The disclosure of Japanese Patent Application Nos. 2002-356957 filed on Dec. 9, 2003 and 2003-050498 filed on Feb. 27, 2003, each including the specification, drawings and abstract are incorporated herein by reference in their entireties.

### BACKGROUND OF THE INVENTION

1. Field of the Invention

The invention relates to a membrane-electrode assembly of a polymer electrolyte fuel cell, and a production method thereof.

2. Description of the Related Art

In a polymer electrolyte fuel cell, a membrane-electrode assembly is generally used, in which carrier supported catalyst-containing ink that includes a catalyst (e.g., gold or platinum), a carrier (e.g., a carbon carrier), and an aqueous solvent or an organic solvent is disposed as a catalytic layer on a solid polymer electrolyte membrane. When producing the membrane-electrode assembly, for example, the ink for the electrode is directly applied to the electrolyte membrane, or the ink for the electrode is applied to a base film, and then the base film is hot-pressed to the electrolyte membrane, whereby the ink as the catalytic layer is transferred onto the electrolyte membrane, as disclosed in Japanese Patent Publication No. 9-501535 and Japanese Patent Laid-Open Publication No. 2001-68119.

The electrolyte membrane may be broken due to projections on a surface of the catalytic layer of the carrier supported catalyst-containing ink, and a pin hole may be generated, which may reduce the performance and the life span of the membrane-electrode assembly. In order to avoid this situation, Japanese Patent Laid-Open Publication No. 11-16584 discloses a technology in which an electrolyte layer made of electrolyte material is further formed between the catalytic layer and the electrolyte membrane.

It is known that the electrolyte membrane may be damaged due to the microscopic projections on the surface of the catalytic layer, which may reduce the performance and the life span of the membrane-electrode assembly when the catalytic layer is formed on the electrolyte membrane using the carrier supported catalyst-containing ink that is generally used. The formation of such projections on the surface is considered to be inevitable, and is accepted. Alternatively, additional means is provided in order to avoid damage, as disclosed in Japanese Patent Laid-Open Publication No. 11-16584. If the additional electrolyte layer is formed as a boundary layer, the thickness of the membrane-electrode assembly is slightly increased, and the number of processes for producing the membrane-electrode assembly is also increased. Therefore, forming the additional electrolyte layer is not a practical solution.

### SUMMARY OF THE INVENTION

It is an object of the invention to provide a membrane-electrode assembly in which microscopic projections that have been considered to be inevitably formed on a catalytic layer of carrier supported catalyst-containing ink are eliminated, or the number of the projections is decreased so as to be small, whereby damage to an electrolyte membrane by the projections can be suppressed, and reductions in the performance and in the life span of the membrane-electrode assembly can be effectively suppressed, and a production method thereof.

A first aspect of the invention relates to a production method of a membrane-electrode assembly which includes a first step of preparing ink including a carrier supported catalyst and a solvent, the carrier supported catalyst including a carrier and a catalyst supported by the carrier; and a second step of applying the ink to an electrolyte membrane. This production method includes a step of reducing the number of agglutinates which are contained in at least one of the carrier and the carrier supported catalyst before the second step is performed.

A second aspect of the invention relates to a production method of a membrane-electrode assembly which includes a first step of preparing ink including a carrier supported catalyst and a solvent, the carrier supported catalyst including a carrier and a catalyst supported by the carrier; a second step of applying the ink to a base film; and a third step of hot-pressing, to an electrolyte membrane, the base film to which the ink has been applied. This production method includes a step of reducing the number of agglutinates which are contained in at least one of the carrier and the carrier supported catalyst before the second step is performed.

The first aspect of the invention relates to the production method of a membrane-electrode assembly, in which the ink for an electrode is directly applied to the electrolyte membrane. The second aspect of the invention relates to the production method of a membrane-electrode assembly, in which the ink is applied to the base film, and then the base film is hot-pressed to the electrolyte membrane. In both the production method according to the first aspect of the invention and the production method according to the second aspect of the invention, the step of reducing the number of the agglutinates in the carrier supported catalyst and/or the carrier is performed, based on the inventor's finding that the microscopic projections, which have been considered to be inevitably formed on the catalytic layer of the ink, are formed due to impurities contained in the carrier. As a result, the surface of the catalytic layer on which there are few agglutinates (catalyst clumps) is formed. Accordingly, it is possible to obtain the membrane-electrode assembly whose durability is improved (i.e., the membrane-electrode assembly in which the discharge time from when discharge starts until when a confining pressure change amount (a cross leak amount) reaches a limit value becomes longer).

Thus, by performing the step of reducing the number of the agglutinates in the carrier supported catalyst and/or the carrier, it is possible to reduce the number of agglutinates (catalyst clumps) in the ink, and to form the surface of the catalytic layer on which there are few agglutinates (catalyst clumps).

In the invention, “crushing” signifies crushing the solid carrier, and “disintegration” signifies crushing and dispersing agglutination of secondary particles.

A third aspect of the invention relates to a production method of a membrane-electrode assembly. The production method includes a step of preparing ink including a carrier supported catalyst and a solvent, the carrier supported catalyst including a carrier and a catalyst supported by the carrier; and a step of applying the ink to an electrolyte membrane. In the production method, a carrier having a low content of impurities that cause formation of agglutinates is used as the carrier which supports the catalyst.

A fourth aspect of the invention relates to a production method of a membrane-electrode assembly. The production method includes a step of preparing ink including a carrier supported catalyst and a solvent, the carrier supported catalyst including a carrier and a catalyst supported by the carrier; a step of applying the ink to a base film; and a step of hot-pressing, to an electrolyte membrane, the base film to which the ink has been applied. In the production method, a carrier having a low content of impurities that cause formation of agglutinates is used as the carrier which supports the catalyst.

The production method according to the third aspect of the invention and the production method according to the fourth aspect of the invention are also based on the inventor's finding that the microscopic projections, which have been considered to be inevitably formed on the catalytic layer of the ink, are formed mainly due to the impurities contained in the carrier. Therefore, the carrier which initially has a low content of impurities is used. By selecting and using ink containing such a carrier, it is possible to form the surface of the catalytic layer on which there are few agglutinates (catalyst clumps), and to obtain the membrane-electrode assembly whose durability is improved.

A fifth aspect of the invention relates to a membrane-electrode assembly obtained using the production methods according to the first to fourth aspects of the invention. The membrane-electrode assembly is formed by applying ink including a carrier supported catalyst and a solvent, the carrier supported catalyst including a carrier and a catalyst supported by the carrier to both sides of an electrolyte membrane. The carrier is a carbon carrier which satisfies at least one of i) a condition that a concentration of vanadium in the carbon carrier is equal to or lower than 0.1% by weight, ii) a condition that a concentration of iron in the carbon carrier is equal to or lower than 0.05% by weight, and iii) a condition that a concentration of nickel in the carbon carrier is equal to or lower than 0.1% by weight.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIGS. 1A and 1B are laser micrographs, each showing the surface of a film of carrier supported catalyst-containing ink;

FIG. 2 is a graph for evaluating durability of electrode modules which are produced using different types of carrier supported catalyst-containing ink;

FIGS. 3A to 3F are micrographs, each showing the surface of a film of carrier supported catalyst-containing ink using a carbon carrier;

FIG. 4 is a graph for evaluating durability of electrode modules in a first embodiment and a second embodiment, and durability of an electrode in a first comparative example;

FIG. 5A is a micrograph showing the surface of a film of carrier supported catalyst-containing ink using a carbon carrier that was not subjected to a crushing process;

FIG. 5B is a micrograph showing the surface of a film of carrier supported catalyst-containing ink using a carbon carrier that was subjected to the crushing process; and

FIG. 6 is a graph for evaluating durability of electrode modules in a third embodiment and a fourth embodiment, and durability of electrode modules in second comparative example.

### DETAILED DESCRIPTION OF THE PREFERRED EMBODIMENTS

The inventor analyzed properties of the surface of a catalytic layer that is formed by applying carrier supported catalyst-containing ink, using micrographs and laser micrographs, and performed empirical experiments concerning a correlation between the properties of the surface of the catalytic layer and durability of a membrane-electrode assembly. As a result, the following was found. The size of a projection on the surface of a film of the carrier supported catalyst-containing ink can be reduced, and the number of projections can be reduced to a certain extent by employing effective methods of preparing and applying the ink. However, depending on the type of ink, it is not possible, by any means, to avoid formation of a projection which is approximately 5 μm in height and 30 μm in diameter on the surface of the film of ink. Also, the number of projections per unit area varies depending on the type of ink. In the invention, the projection of such size is referred to as “catalyst clump” or “agglutinate”.

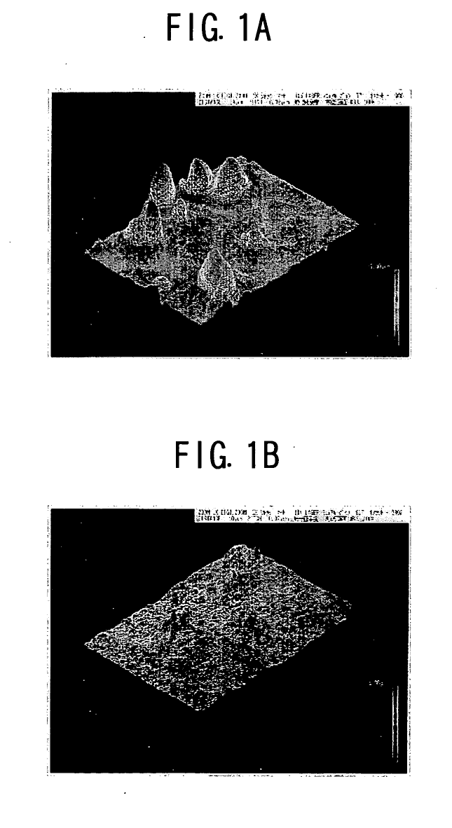

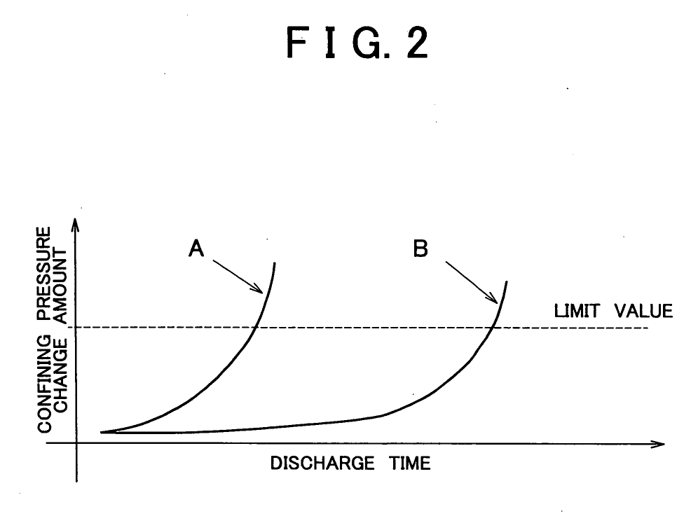

FIG. 1A is a laser micrograph showing the surface of a film on which there are many catalyst clumps. FIG. 1B is a laser micrograph showing the surface of a film on which there are few catalyst clumps, compared with the surface of the film shown in FIG. 1A. In FIG. 1A, approximately 70 catalyst clumps, each of which is approximately 5 μm in height and approximately 30 μm in diameter, are formed per 1 mm². In FIG. 1B, approximately 60 catalyst clumps are formed per 1 mm². FIG. 2 is a graph for evaluating durability (confining pressure change amounts) of membrane-electrode assemblies each of which has a catalytic layer formed using a different type of ink. The graph shows that there is a great difference in the time required for a confining pressure change amount to reach a limit value between a film A (shown in FIG. 1A) and a film B (shown in FIG. 1B). This signifies that the durability of the membrane-electrode assembly is improved by reducing the number of the catalyst clumps (agglutinates) in the carrier supported catalyst-containing ink even when the same ink is used. In the embodiments, the “confining pressure change amount” signifies the amount of gas which passes through an area of 1 cm² of a membrane-electrode assembly per 1 second at 1 atmospheric pressure.

Subsequently, the inventor performed analytic experiments using several types of carrier supported catalyst-containing ink in order to study how the catalyst clumps (agglutinates) are formed. As a result, it was found that the number of catalyst clumps increases with an increase in the amount of impurities contained in the carbon carrier in the case where the catalyst is noble metal, and the carrier is the carbon carrier. Therefore, it is considered that a portion of the catalyst carrier (carbon carrier) which contains many impurities is formed into solid agglutinates of carbon, and the solid agglutinates remain in the ink as the catalyst clumps that cannot be avoided.

Accordingly, types of impurities contained in the carbon carriers of different types were studied using XRF method. As a result, sulfur (S), vanadium (V), iron (Fe), nickel (Ni), and sodium (Na) were mainly detected. The concentrations thereof varied depending on the types of the carbon carrier, as shown in Table 1.

TABLE 1

| Type of | | | | | |
|---|---|---|---|---|---|
| Carbon | Impurities | Impurities | Impurities | Impurities | Impurities |
| Carrier | Sulfur | Vanadium | Iron | Nickel | Sodium |
| A | 0.29 | 0.53 | 0.18 | 0.30 | 0.025 |
| B | 0.33 | 0.59 | 0.17 | 0.31 | 0.025 |
| C | 0.26 | 0.35 | 0.12 | 0.18 | 0.025 |
| D | 0.19 | 0.055 | 0.032 | 0.046 | 0.010 |
| E | 0.034 | 0.000 | 0.004 | 0.002 | 0.000 |
| F | 0.870 | 0.000 | 0.001 | 0.002 | 0.010 |

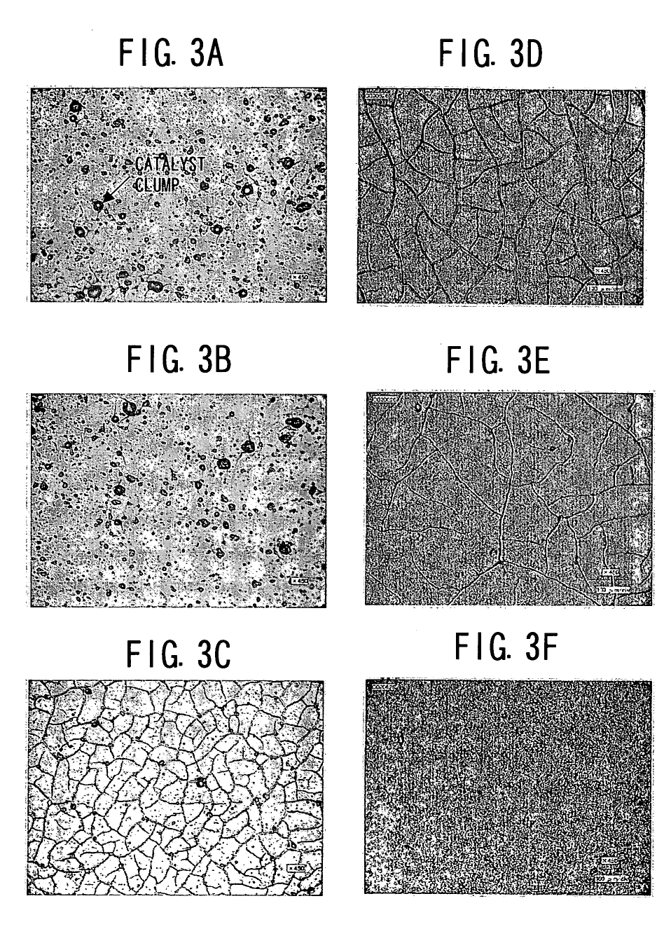

FIG. 3A to FIG. 3F are microphotos (at a magnification of 450) showing the states of the surfaces of the films formed using 6 types of carrier supported catalyst-containing ink. The 6 types of carrier supported catalyst-containing ink were produced in the same manner except that each of the aforementioned carbon carriers A to F was used as a catalyst carrier. FIG. 3A to FIG. 3F correspond to the carbon carriers A to F, respectively. The numbers of the formed catalyst clumps in the cases of the carbon carriers A to F are shown in Table 2. Based on the results, it was found that there is evidently a correlation between the total concentration of impurities (% by weight) and the number of the formed catalyst clumps. Also, it was found that the concentrations of some impurities (vanadium and iron) greatly influences the number of the formed catalyst clumps, and the concentrations of some impurities (sulfur and sodium) do not greatly influence the number of the formed catalyst clumps.

TABLE 2

Type of Carbon Carrier

| | A | B | C | D | E | F |
|---|---|---|---|---|---|---|
| Number of Formed | 70 | 60 | 30 | 4 | 4 | 4 |
| Catalyst Clumps | | | | | | |
| (per mm²) | | | | | | |

Hereinafter, embodiments of the invention and comparative examples will be described. Obviously, the invention is not limited to the following embodiments.

### First Embodiment

As a carbon carrier for a cathode catalyst, a carbon carrier containing 0.19% by weight of sulfur, 0.055% by weight of vanadium, 0.032% by weight of iron, 0.046% by weight of nickel, and 0.01% by weight of sodium as impurities was used. Platinum is supported by the carbon carrier such that the weight of the platinum is equal to 60% of the total weight of a carbon carrier supported platinum, whereby a carbon carrier supported platinum for the cathode was produced. The carbon carrier supported platinum for the cathode, water, ethanol, propylene glycol, and a 10% of electrolyte solution were blended, whereby catalytic ink for the cathode was produced.

The catalytic ink for the cathode was applied to a Teflon sheet that was base sheet such that a film was formed on the Teflon sheet (the thickness of the film (in a wet state): 130 μm, the amount of platinum catalyst: 0.45 mg Pt/cm²), and was dried (drying temperature: 100° C.), whereby a cathode catalytic layer was formed on the base sheet for transfer. The catalytic layer thus formed was continuously transferred onto a reinforced membrane that includes an electrolyte membrane having the thickness of 30 μm (Gore-Select (brand name) manufactured by Japan Gore-Tex Inc.) and another membrane (transfer temperature: 130° C., transfer pressure: 30 kgf/cm², i.e., 2.94 MPa).

As a carbon carrier for an anode catalyst, a carbon carrier containing 0.87% by weight of sulfur, 0.0% by weight of vanadium, 0.001% by weight of iron, 0.002% by weight of nickel, and 0.01% by weight of sodium as impurities was used. Platinum is supported by the carbon carrier such that the weight of the platinum is equal to 30% of the total weight of a carbon carrier supported platinum, whereby a carbon carrier supported platinum for the anode was produced. The carbon carrier supported platinum for the anode, water, ethanol, propylene glycol, and a 10% of electrolyte solution were blended, whereby catalytic ink for the anode was produced.

The catalytic ink for the anode was applied to a Teflon sheet that was base sheet such that a film was formed on the Teflon sheet (the thickness of the film (in the wet state): 45 μm, the amount of platinum catalyst: 0.15 mg Pt/cm²), and was dried (drying temperature: 100° C.), whereby an anode catalytic layer was formed on the base sheet for transfer. The anode catalytic layer thus formed was continuously transferred onto the reinforced membrane that includes the electrolyte membrane having the thickness of 30 μm (Gore-Select (brand name) manufactured by Japan Gore-Tex Inc.) and another membrane (transfer temperature: 130° C., transfer pressure: 30 kgf/cm², i.e., 2.94 MPa), while the cathode catalytic layer was continuously transferred. Thus, a membrane-electrode assembly was obtained.

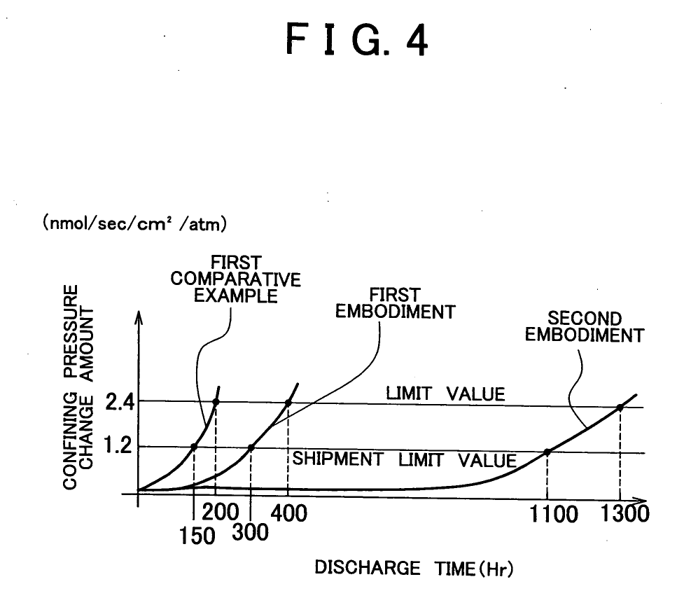

A diffusion layer was transferred onto each of the cathode catalytic layer and the anode catalytic layer of the obtained membrane-electrode assembly (transfer temperature: 100° C., transfer pressure: 30 kgf/cm², i.e., 2.94 MPa) so that electrodes were formed. Then, a baked separator was fitted thereto so that an electrode module was formed. The initial discharge performance and the durability of the discharge performance of the electrode module were measured and evaluated. As a method of evaluating the durability, the confining pressure change amount in the electrode module was measured. The result is shown in FIG. 4.

### Second Embodiment

As a carbon carrier for a cathode catalyst, a carbon carrier containing 0.19% by weight of sulfur, 0.055% by weight of vanadium, 0.032% by weight of iron, 0.046% by weight of nickel, and 0.01% by weight of sodium as impurities was used. Platinum is supported by the carbon carrier such that the weight of the platinum is equal to 60% of the total weight of a carbon carrier supported platinum, whereby a carbon carrier supported platinum for the cathode was produced. The carbon carrier supported platinum for the cathode, water, ethanol, propylene glycol, and a 10% of electrolyte solution were blended, and then the carbon carrier supported platinum was disintegrated by a jet mill as a disintegrator (disintegrating condition: 150 MPa/three passes) and was dispersed, whereby catalytic ink for the cathode was produced. Then, pressure filtration of the catalytic ink was performed using a filter (pressurizing condition: 3.5 kgf/cm², i.e., 0.34 MPa, filter mesh: 10 μm), whereby catalyst clumps were separated and removed through filtration.

The catalytic ink for the cathode was applied to a Teflon sheet that was base sheet such that a film was formed on the Teflon sheet (the thickness of the film (in the wet state): 130 μm, the amount of platinum catalyst: 0.45 mg Pt/cm²), and was dried (the drying temperature: 100° C.), whereby a cathode catalytic layer was formed on the base sheet for transfer. The catalytic layer thus formed was continuously transferred onto a reinforced membrane that includes the electrolyte membrane having the thickness of 30 μm (Gore-Select (brand name) manufactured by Japan Gore-Tex Inc.) and another membrane (transfer temperature: 130° C., transfer pressure: 30 kgf/cm², i.e., 2.94 MPa).

As a carbon carrier for an anode catalyst, a carbon carrier containing 0.87% by weight of sulfur, 0.0% by weight of vanadium, 0.001% by weight of iron, 0.002% by weight of nickel, and 0.01% by weight of sodium as impurities was used. Platinum is supported by the carbon carrier such that the weight of the platinum is equal to 30% of the total weight of a carbon carrier supported platinum, whereby a carbon carrier supported platinum for the anode was produced. The carbon carrier supported platinum for the anode, water, ethanol, propylene glycol, and a 10% of electrolyte solution were blended, and then the carbon carrier supported platinum was disintegrated by the jet mill as the disintegrator (disintegrating condition: 150 MPa/three passes) and was dispersed, whereby catalytic ink for the anode was produced. Then, pressure filtration of the catalytic ink was performed using a filter (pressurizing condition: 3.5 kgf/cm², i.e., 0.34 MPa, filter mesh: 10 μm), whereby catalyst clumps were separated and removed through filtration.

The catalytic ink for the anode was applied to a Teflon sheet that was base sheet such that a film was formed on the Teflon sheet (the thickness of the film (in the wet state): 45 μm, the amount of platinum catalyst: 0.15 mg Pt/cm²), and was dried (drying temperature: 100° C.), whereby an anode catalytic layer was formed on the base sheet for transfer. The anode catalytic layer thus formed was continuously transferred onto the reinforced membrane that includes the electrolyte membrane having the thickness of 30 μm (Gore-Select (brand name) manufactured by Japan Gore-Tex Inc.) and another membrane (transfer temperature: 130° C., transfer pressure: 30 kgf/cm², i.e., 2.94 MPa), while the cathode catalytic layer was continuously transferred. Thus, a membrane-electrode assembly was obtained.

A diffusion layer was transferred onto each of the cathode catalytic layer and the anode catalytic layer of the obtained membrane-electrode assembly (transfer temperature: 100° C., transfer pressure: 30 kgf/cm², i.e., 2.94 MPa) so that electrodes were formed. Then, a baked separator was fitted thereto so that an electrode module was formed. The initial discharge performance and the durability of the discharge performance of the electrode module were measured and evaluated. As a method of evaluating the durability, the confining pressure change amount in the electrode module was measured. The result is shown in FIG. 4.

### FIRST COMPARATIVE EXAMPLE

A carbon carrier containing 0.29% by weight of sulfur, 0.53% by weight of vanadium, 0.18% by weight of iron, 0.3% by weight of nickel, and 0.025% by weight of sodium as impurities was used, as a carbon carrier for a cathode catalyst and a carbon carrier for an anode catalyst. Except for this point, catalytic ink for the cathode and catalytic ink for the anode were produced in the same manner as in the first embodiment. Using catalytic ink for the cathode and catalytic ink for the anode, a membrane-electrode assembly was produced, and further, an electrode module was produced in the same manner as in the first embodiment. The initial discharge performance and the durability of the discharge performance of the electrode module were measured and evaluated. As a method of evaluating the durability, the confining pressure change amount in the electrode module was measured. The result is shown in FIG. 4.

[Evaluation]

As shown in FIG. 4, the initial discharge performance of the electrode module in the first embodiment is the same as that of the electrode module in the first comparative example. However, in the case of the electrode module in the first embodiment, the increase in the confining pressure change amount is small and the durable period of the discharge performance is long, compared with the electrode module in the first comparative example. Further, the durable period of the discharge performance of the electrode module in the second embodiment is longer than that of the electrode module in the first embodiment. Based on the results, it can be presumed that the number of the catalyst clumps was reduced by using the carbon carrier having a lower content of impurities, and therefore the life span of the electrode was increased. Also, it can be presumed that the number of the catalyst clumps was further reduced by subjecting the ink to the filtration process or the disintegrating process, and therefore the life span of the electrode was further increased. Thus, the results prove the effectiveness of the invention.

### Third Embodiment

As a carbon carrier for a cathode catalyst, a carbon carrier containing 0.27% by weight of sulfur, 0.022% by weight of sodium, 0.39% by weight of vanadium, 0.14% by weight of iron, and 0.28% by weight of nickel as impurities was used, as shown in Table 3. With regard to the particle size distribution of the carbon carrier, a minimum diameter was 0.056 μm, a median diameter was 0.254 μm, and a maximum diameter was 7.778 μm. The carbon carrier was crushed by a dry/wet type crusher (manufactured by Hosokawamicron corporation: a fluidized bed jet mill, AFG200/1). After the crushing process is performed, the carbon carrier was taken out. Then, the particle size distribution and the concentrations of impurities of the carbon carrier were measured in the same manner. With regard to the particle size distribution of the carbon carrier which was subjected to the crushing process, the minimum diameter was 0.047 μm, the median diameter was 0.198 μm, and the maximum diameter was 2.313 μm. The carbon carrier contained 0.28% by weight of sulfur, 0.015% by weight of sodium, 0.21% by weight of vanadium, 0.081% by weight of iron, and 0.12% by weight of nickel as impurities, as shown in Table. 3.

TABLE 3

| | Impurities (% by weight) | | | | |
|---|---|---|---|---|---|
| | Sulfur | Sodium | Vanadium | Iron | Nickel |
| Carbon Carrier | 0.27 | 0.022 | 0.39 | 0.14 | 0.28 |
| Carbon Carrier | 0.28 | 0.015 | 0.21 | 0.081 | 0.12 |
| after Crushing | | | | | |

Platinum is supported by the carbon carrier, which was subjected to the crushing process, such that the weight of the platinum is equal to 60% of the total weight of a carbon carrier supported platinum, whereby a carbon carrier supported platinum for the cathode was produced. The carbon carrier supported platinum for the cathode, water, ethanol, propylene glycol, and a 10% of electrolyte solution were blended, whereby catalytic ink for the cathode was produced.

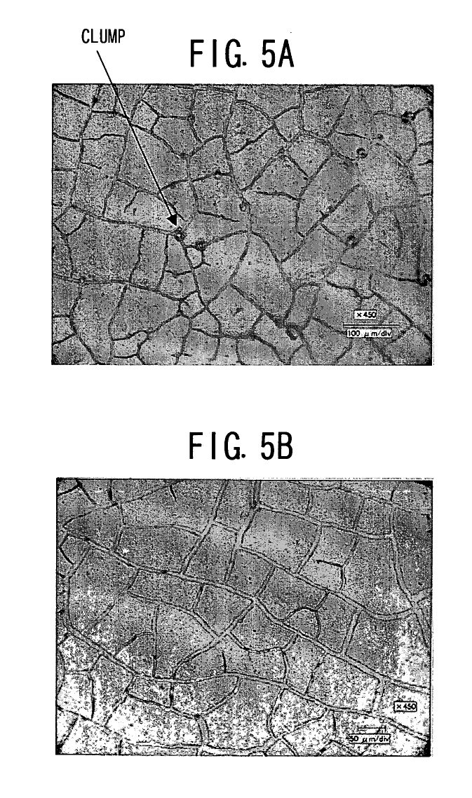

The catalytic ink for the cathode was applied to a Teflon sheet that was base sheet such that a film was formed on the Teflon sheet (the thickness of the film (in the wet state): 130 μm, the amount of platinum catalyst: 0.45 mg Pt/cm²), and was dried (the drying temperature: 100° C.), whereby a cathode catalytic layer was formed on the base sheet for transfer. FIG. 5B is a microphoto showing the surface of the film. In FIG. 5B, black particles are agglutinates (catalyst clumps). The number of the catalyst clumps was evidently reduced as compared with the surface of a film (shown in FIG. 5A) of catalytic ink which was not subjected to the crushing process in a second comparative example described later. The catalytic layer thus formed was continuously transferred onto a reinforced membrane that includes the electrolyte membrane having the thickness of 30 μm (Gore-Select (brand name) manufactured by Japan Gore-Tex Inc.) and another membrane (transfer temperature: 130° C., transfer pressure: 30 kgf/cm², i.e., 2.94 MPa). As a carbon carrier for an anode catalyst, a carbon carrier having a low content of impurities was used, as compared with the carbon carrier which was the same as that used for the cathode catalyst, but was not subjected to the crushing process. The carbon carrier contained 0.87% by weight of sulfur, 0.01% by weight of sodium, 0.0% by weight of vanadium, 0.001% by weight of iron, and 0.002% by weight of nickel as impurities. Platinum is supported by the carbon carrier such that the weight of the platinum is equal to 30% of the total weight of a carbon carrier supported platinum, whereby a carbon carrier supported platinum for the anode was produced. The carbon carrier supported platinum for the anode, water, ethanol, propylene glycol, and a 10% of electrolyte solution were blended, whereby catalytic ink for the anode was produced. The catalytic ink for the anode was applied to a Teflon sheet that was base sheet such that a film was formed on the Teflon sheet (the thickness of the film (in a wet state): 45 μm, the amount of platinum catalyst: 0.15 mg Pt/cm²), and was dried (drying temperature: 100° C.), whereby an anode catalytic layer was formed on the base sheet for transfer. The anode catalytic layer thus formed was continuously transferred onto the reinforced membrane that includes the electrolyte membrane having the thickness of 30 μm (Gore-Select (brand name) manufactured by Japan Gore-Tex Inc.) and another membrane (transfer temperature: 130° C., transfer pressure: 30 kgf/cm², i.e., 2.94 MPa), while the cathode catalytic layer was continuously transferred.

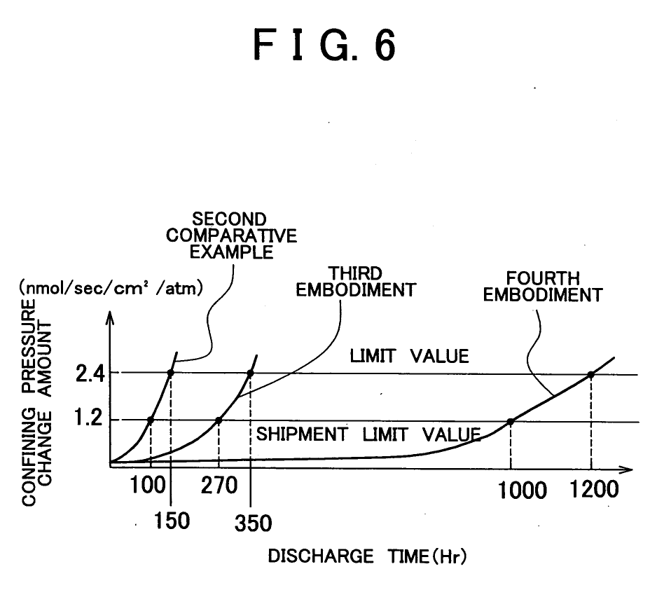

A diffusion layer was transferred onto each of the cathode catalytic layer and the anode catalytic layer (transfer temperature: 100° C., transfer pressure: 30 kgf/cm², i.e., 2.94 MPa) so that electrodes were formed. Then, a baked separator was fitted thereto so that an electrode module was formed. The initial discharge performance and the durability of the discharge performance of the electrode module were measured and evaluated. As a method of evaluating the durability, the confining pressure change amount in the electrode module was measured. The result is shown in FIG. 6.

### Fourth Embodiment

Platinum is supported by the carbon carrier, which was subjected to the crushing process, such that the weight of the platinum is equal to 60% of the total weight of a carbon carrier supported platinum, whereby a carbon carrier supported platinum for a cathode was produced. The carbon carrier supported platinum for the cathode, water, ethanol, propylene glycol, and a 10% of electrolyte solution were blended, and then the carbon carrier supported platinum was disintegrated by the wet type jet mill as the disintegrator (disintegrating condition: 150 MPa/three passes) and was dispersed, whereby catalytic ink for the cathode was produced. Then, pressure filtration of the catalytic ink was performed using a filter (pressurizing condition: 3.5 kgf/cm², i.e., 0.34 MPa, filter mesh: 10 μm), whereby catalyst clumps were separated and removed through filtration. The catalytic ink for the cathode was applied to a Teflon sheet that was base sheet such that a film was formed on the Teflon sheet (the thickness of the film (in a wet state): 130 μm, the amount of platinum catalyst: 0.45 mg Pt/cm²), and was dried (drying temperature: 100° C.), whereby a cathode catalytic layer was formed on the base sheet for transfer. The catalytic layer thus formed was continuously transferred onto a reinforced membrane that includes the electrolyte membrane having the thickness of 30 μm (Gore-Select (brand name) manufactured by Japan Gore-Tex Inc.) and another membrane (transfer temperature: 130° C., transfer pressure: 30 kgf/cm², i.e., 2.94 MPa).

As a carbon carrier for an anode catalyst, the same carbon carrier for the anode as in the first embodiment was used. Platinum is supported by the carbon carrier such that the weight of the platinum is equal to 30% of the total weight of a carbon carrier supported platinum whereby a carbon carrier supported platinum for the anode was produced. The carbon carrier supported platinum for the anode, water, ethanol, propylene glycol, and a 10% of electrolyte solution were blended, and then the carbon carrier supported platinum was disintegrated by the wet type jet mill as the disintegrator (disintegrating condition: 150 MPa/three passes) and was dispersed, whereby catalytic ink for the anode was produced. Then, pressure filtration of the catalytic ink was performed using a filter (pressurizing condition: 3.5 kgf/cm², i.e., 0.34 MPa, filter mesh: 10 μm), whereby catalyst clumps were separated and removed through filtration.

The catalytic ink for the anode was applied to a Teflon sheet that was base sheet such that a film was formed on the Teflon sheet (the thickness of the film (in a wet state): 45 μm, the amount of platinum catalyst: 0.15 mg Pt/cm²), and was dried (drying temperature: 100° C.), whereby a anode catalytic layer was formed on the base sheet for transfer. The catalytic layer thus formed was continuously transferred onto the reinforced membrane that includes the electrolyte membrane having the thickness of 30 μm (Gore-Select (brand name) manufactured by Japan Gore-Tex Inc.) and another membrane (the transfer temperature: 130° C., the transfer pressure: 30 kgf/cm², i.e., 2.94 MPa).

A diffusion layer was transferred onto each of the cathode catalytic layer and the anode catalytic layer (transfer temperature: 100° C., transfer pressure: 30 kgf/cm², i.e., 2.94 MPa) so that electrodes were formed. Then, a baked separator was fitted thereto so that an electrode module was formed. The initial discharge performance and the durability of the discharge performance of the electrode module were measured and evaluated. As a method of evaluating the durability, the confining pressure change amount in the electrode module was measured. The result is shown in FIG. 6.

### SECOND COMPARATIVE EXAMPLE

As a carbon carrier for a cathode catalyst, the carbon carrier which was the same as in the third embodiment, but was not subjected to the crushing process was used. Platinum is supported by the carbon carrier such that the weight of the platinum is equal to 60% of the total weight of a carbon carrier supported platinum, whereby a carbon carrier supported platinum for the cathode was produced. Except for this point, catalytic ink for the cathode was produced in the same manner as in the first embodiment, and was applied to a Teflon sheet that was base sheet such that a film was formed on the Teflon sheet. FIG. 5A is a microphoto showing the surface of the film of the catalytic ink. Using the catalytic ink, a membrane-electrode assembly was produced, and further, an electrode module was produced in the same manner as in the third embodiment. The initial discharge performance and the durability of the discharge performance of the electrode module were measured and evaluated. As a method of evaluating the durability, the confining pressure change amount in the electrode module was measured. The result is shown in FIG. 6.

[Evaluation]

As shown in FIG. 6, the initial discharge performance of the electrode module in the third embodiment is the same as that of the electrode module in the second comparative example. However, in the case of the electrode module in the third embodiment, the increase in the confining pressure change amount is small and the durable period of the discharge performance is long, compared with the electrode module in the second comparative example. Based on the results, it can be presumed that the number of the catalyst clumps was reduced by using the carbon carrier having a lower content of impurities due to the crushing process, and therefore the life span of the electrode was increased. Also, the durable period of the electrode module in the fourth embodiment was longer than that of the electrode module in the third embodiment. Based on the result, it can be presumed that the number of the catalyst clumps was further reduced by subjecting the ink to the filtration process or the disintegrating process in addition to the crushing process, and therefore the life span of the electrode was further increased. Thus, the results prove the effectiveness of the embodiments of the invention.

In the second embodiment and the fourth embodiment, the carbon carrier which supported platinum catalyst in the catalytic ink was disintegrated. However, the carbon carrier which supports platinum catalyst may be disintegrated before the catalytic ink is prepared. Also, a carbon carrier which does not support platinum catalyst may be put in the catalytic ink in the first to fourth embodiments, and the carbon carrier which does not support platinum catalyst may be disintegrated and/or be filtered together with the carbon carrier which supports platinum catalyst. Also, the number of the agglutinates in the carrier and the carrier supported catalyst may be reduced by crushing or disintegrating the agglutinates are physically using a mechanical crusher or a mechanical disintegrator such as a wet type get mill.

According to the aforementioned embodiments of the invention, it is possible to suppress formation of the catalyst clumps on the surface of the catalytic layer of the carrier supported catalyst-containing ink, to prevent damage to the electrolyte membrane, and to improve the durability of the membrane-electrode assembly.

What is claimed is:

1. A production method of a membrane-electrode assembly, comprising:
a first step of preparing ink including a carrier supported catalyst and a solvent, the carrier supported catalyst including a carrier and a catalyst supported by the carrier;
a second step of applying the ink to an electrolyte membrane; and
a reducing step of reducing the number of agglutinates which are contained in at least one of the carrier and the carrier supported catalyst before the second step is performed.

2. The production method according to claim 1, wherein the number of the agglutinates in the carrier is reduced in the reducing step before the first step is performed.

3. The production method according to claim 1, wherein the number of the agglutinates contained in at least one of the carrier and the carrier supported catalyst in the ink is reduced in the reducing step before the second step is performed.

4. The production method according to claim 3, wherein the number of the agglutinates contained in at least one of the carrier and the carrier supported catalyst is reduced in the reducing step while the first step is performed.

5. The production method according to claim 3, wherein the number of the agglutinates contained in at least one of the carrier and the carrier supported catalyst is reduced in the reducing step after the first step is performed and before the second step is performed.

6. The production method according to claim 1, wherein the number of the agglutinates contained in the carrier supported catalyst is reduced in the reducing step before the first step is performed.

7. The production method according to claim 1, wherein the reducing step includes at least one of a crushing step and a disintegrating step.

8. The production method according to claim 1, wherein the reducing step includes a filtration step.

9. A production method of a membrane-electrode assembly, comprising:
a first step of preparing ink including a carrier supported catalyst and a solvent, the carrier supported catalyst including a carrier and a catalyst supported by the carrier;
a second step of applying the ink to a base film; and a third step of hot-pressing, to an electrolyte membrane, the base film to which the ink has been applied; and
a reducing step of reducing the number of agglutinates which are contained in at least one of the carrier and the carrier supported catalyst before the second step is performed.

10. The production method according to claim 9, wherein the number of the agglutinates in the carrier is reduced in the reducing step before the first step is performed.

11. The production method according to claim 9, wherein the number of the agglutinates contained in at least one of the carrier and the carrier supported catalyst in the ink is reduced in the reducing step before the second step is performed.

12. The production method according to claim 11, wherein the number of the agglutinates contained in at least one of the carrier and the carrier supported catalyst is reduced in the reducing step while the first step is performed.

13. The production method according to claim 11, wherein the number of the agglutinates contained in at least one of the carrier and the carrier supported catalyst is reduced in the reducing step after the first step is performed and before the second step is performed.

14. The production method according to claim 9, wherein the number of the agglutinates contained in the carrier supported catalyst is reduced in the reducing step before the first step is performed.

15. The production method according to claim 9, wherein the reducing step includes at least one of a crushing step and a disintegrating step.

16. The production method according to claim 9, wherein the reducing step includes a filtration step.

17. A production method of a membrane-electrode assembly comprising
a step of preparing ink including a carrier supported catalyst and a solvent, the carrier supported catalyst including a carrier having a low content of impurities that cause formation of agglutinates and a catalyst supported by the carrier; and
a step of applying the carrier supported catalyst ink to an electrolyte membrane.

18. The production method according to claim 17, wherein the carrier is a carbon carrier, and the impurities includes at least one of vanadium (V), iron (Fe), and nickel (Ni).

19. The production method according to claim 18, wherein the carbon carrier satisfies at least one of i) a condition that a concentration of vanadium in the carbon carrier is equal to or lower than 0.1% by weight, ii) a condition that a concentration of iron in the carbon carrier is equal to or lower than 0.05% by weight, and iii) a condition that a concentration of nickel in the carbon carrier is equal to or lower than 0.1% by weight.

20. A production method of a membrane-electrode assembly comprising
a step of preparing ink including a carrier supported catalyst and a solvent, the carrier supported catalyst including a carrier having a low content of impurities that cause formation of agglutinates and a catalyst supported by the carrier; and
a step of applying the ink to a base film; and
a step of hot-pressing, to an electrolyte membrane, the base film to which the ink has been applied.

21. The production method according to claim 20, wherein the carrier is a carbon carrier, and the impurities includes at least one of vanadium (V), iron (Fe), and nickel (Ni).

22. The production method according to claim 21, wherein the carbon carrier satisfies at least one of i) a condition that a concentration of vanadium in the carbon carrier is equal to or lower than 0.1% by weight, ii) a condition that a concentration of iron in the carbon carrier is equal to or lower than 0.05% by weight, and iii) a condition that a concentration of nickel in the carbon carrier is equal to or lower than 0.1% by weight.

23. A membrane-electrode assembly, comprising:
an electrolyte membrane; and
an electrode which is formed on both sides of the electrolyte membrane using carrier supported catalyst-containing ink that includes a catalyst, a carrier, and a solvent,
wherein the carrier is a carbon carrier which satisfies at least one of i) a condition that a concentration of vanadium in the carbon carrier is equal to or lower than 0.1% by weight, ii) a condition that a concentration of iron in the carbon carrier is equal to or lower than 0.05% by weight, and iii) a condition that a concentration of nickel in the carbon carrier is equal to or lower than 0.1% by weight.
